(19) United States
(12) Patent Application Publication
(10) Pub. No.: US 2017/0306843 A1
(43) Pub. Date: Oct. 26, 2017

(54) METHOD AND APPARATUS FOR INCREASING USEFUL ENERGY/THRUST OF A GAS TURBINE ENGINE BY ONE OR MORE ROTATING FLUID MOVING (AGITATOR) PIECES DUE TO FORMATION OF A DEFINED STEAM REGION

(71) Applicant: Leonard Morgensen Andersen, New York, NY (US)

(72) Inventor: Leonard Morgensen Andersen, New York, NY (US)

(21) Appl. No.: 15/443,692

(22) Filed: Feb. 27, 2017

Related U.S. Application Data
(60) Provisional application No. 62/387,515, filed on Dec. 30, 2015.

(51) Int. Cl. F02C 3/30; B01F 5/10; B01F 5/02; F01K 21/04

(52) U.S. Cl. CPC F02C 3/305; F01K 21/047; F01K 21/045; B01F 5/0231; B01F 5/0243; B01F 5/106

(57) ABSTRACT

A system for increasing useful energy output includes a source of hot combustion gas, such as from a gas turbine engine, and an apparatus that is disposed downstream of and receives the hot combustion gas and acts thereon to optimize electricity/thrust energy output of the system. The apparatus includes a housing that is coupled to the source and receives the hot combustion gas and also includes a rotatable shaft centrally disposed within the housing. A rotatable fluid moving device is coupled to the rotatable shaft and is configured such that the rotatable fluid moving device moves the hot combustion gas into a shape within the housing such that useful energy output/thrust is increased. Optionally, the system includes a spray nozzle that discharges water droplets upstream of the rotatable fluid moving device in a high temperature environment such that the action of the rotatable fluid moving device generates water vapor (steam) having a particular profile (e.g., annular shaped).

### CROSS REFERENCE TO RELATED APPLICATION

The present claims priority to and the benefit of U.S. patent application Ser. No. 62/387,515, filed on Dec. 30, 2015, which is hereby incorporated by reference in its entirety.

### TECHNICAL FIELD

The present invention generally relates to gas turbine engines or other devices that generate hot combustion gas and in particular, to the use of a rotating agitator/mixer (fluid moving element or device) that is configured to act on the hot combustion gas generated by the gas turbine engine (hot thrust gas) so as to increase energy output per unit of fuel and this can be in the form of generation of electricity or increased thrust energy output in an aircraft or the like). In one exemplary embodiment, the system also includes a rotatable fluid sprayer that discharges water, in a swirling manner, into the hot thrust gases to form water droplets that are then acted upon by the fluid moving device which results in optimal conversion of the water droplets into water vapor (steam) which then acts on a downstream device.

### BACKGROUND

Gas turbine engines (also called combustion turbines) can be used in many different commercial settings. For example, gas turbine engines are used in jet engines, turboprop engines, auxiliary power units, industrial power generation systems, and industrial mechanical drive systems, etc.

In the jet engine and the turbine engine technical fields, there has been a constant endeavor to increase energy output per unit of fuel. Generally, in a gas turbine installation, a part of compressed air generated from a compressor is used for turbine cooling. Thus, an improvement in power efficiency and an increase in an output of a gas turbine system can be achieved by increasing the cooling capability of cooling air and reducing the amount of compressed air required for cooling. To that end, a technique for reducing the flow rate of compressed air required for cooling blades is practiced. A turbine blade cooling circuit is often used. However, the high pressure from the compressor makes it difficult for the turbine blade cooling circuit to operate in an ideal manner.

A gas turbine or jet engine typically includes a compressor assembly for compressing a working fluid, such as air. The compressed air is flowed into a combustor which heats the fluid causing it to expand. The expanded fluid is then forced through the turbine.

The output of known gas turbine engines is limited by an operating temperature of the working fluid at the output of the compressor assembly. At least some known turbine engines include compressor cooling devices, such as intercoolers, to extract heat from the compressed air to reduce the operating temperature of the flow exiting the compressor. As a result of the decreased temperatures, increased power output can be achieved by increasing flow through the compressor assembly.

To facilitate additional cooling, at least some gas turbine engines include water injection systems that overcome some of the shortcomings associated with intercoolers. Such systems use a plurality of nozzles to inject water into the flow during engine operation.

The essential goal in designing the jet engine has always been to produce more thrust and fuel efficiency to achieve turbine durability (that is, an improved component life). To do so, the combustor needs to operate at a higher temperature, which requires cooling the turbine. The first mass produced axial engine, Jumo 004B, utilized internal cooling for the turbine blades. So, the concept is as old as the turbojet engine itself. Fuel efficiency can further be enhanced by cooling the turbine blades with airflow or liquid-flow into gas (steam) through them. Afterburners provide a means for an emergency boost; however, they suffer from fuel inefficiency relative to the other working components of the turbine.

FIG. 1 illustrates a conventional driven apparatus 10 that contains an engine and in particular, the apparatus 10 is in the form of an aircraft that includes a turbine engine 20. However, the present invention is not limited to being used in an aircraft and it will be appreciated that it equally can be used in other gas turbine settings including a vehicle, ship, electrical power generation, etc. As shown in FIG. 2, the turbine engine 20 includes a number of components some of which can be broadly categorized and identified as a compressor 30, a combustion chamber 40, a fuel burner 50, a turbine 55, and a nozzle 70. FIG. 2 illustrates one exemplary form of a turbine engine in the form of a jet engine, a turbojet, a gas turbine, a ramjet, or a scramjet engines; however, it will be appreciated that the turbine engine 20 can be of another engine type.

FIG. 2 illustrates an overview of the jet engine 20, wherein air 21 is drawn into the turbojet by the high by-pass fan 25 and the compressor 30. The compressor 30 is basically a large spinning fan. The compressor slows down the incoming air, raising its pressure, and delivers it to the combustion chamber 40. Fuel is injected into the high-pressure air in the combustion chamber and ignited by the fuel burner 50. The resulting hot gases 41 expand and rush first through the turbine 55 and then through the nozzle or exhaust section 70 located at the rear. A rotating shaft 80 may connect all the above components to provide momentum when rotating. A forward thrust is generated as a reaction to the rearward momentum of the exhaust gases.

The turbine 55 includes a series of bladed discs (turbine blades 60) that act similar to a windmill, gaining energy from the hot gases 41 leaving the combustor. Some of this energy is used to drive the compressor, and in some turbine engines (i.e., turboprop, turboshaft or turbofan engines), energy is extracted by additional turbine discs and used to drive devices such as propellers, bypass fans, helicopter rotors or electrical generators. These series of bladed discs are known as turbine blades.

The hot exhaust 41 acts on the turbine blades 60, while leaving the combustion chamber 40 causing the turbine blades 60 to spin around. A forward thrust is generated as a reaction to the rearward momentum of the exhaust gases when the hot gasses 41 rush toward the blades leaving the nozzle (exhaust section) 70. The turbine 55 is designed to provide mechanical energy and rotation to the compressor.

The purpose of the turbine is to provide momentum to the compressor 30 that is attached by the rotating shaft 80, thereby enabling the compressor 30 to continually draw in more air. Thus, the air that is compressed in the compressor 30 and then heated in the combustion chamber 40 is not only used to provide a forward thrust but also to drive the turbine 55 that drives the compressor 30 that compresses the air.

The difficulty with making the exhaust gases drive a turbine 55 is that the forward thrust depends upon the difference in pressure between the closed and open ends of the combustion chamber 40, and if the escaping gases have to push against an object (e.g., the turbine blades) that difference in pressure is lessened. In other words, a pressure at the rear of the system detracts from the forward thrust. Thus, the designer's aim in a turbojet engine is to reduce to a minimum the power taken by the turbine 60 to compress the air so that the maximum amount of forward thrust is available.

Gas turbine engines are thus rotary internal combustion engines with an air compressor followed by a combustion section followed by a turbine section. Useful work is obtained from the shaft(s) connecting the compressor to the turbine and from flow of hot gas coming out of the turbine section. More recently, the hot thrust gas has been used to heat steam boilers creating steam which drives a steam turbine. This arrangement is called combined cycle power.

In the last five years, there has been work in mixing water with one or more rotary pieces to generate small droplets going to steam in a swirling pattern with the main shaft of the gas turbine as a center line of the swirling action. Such an arrangement is covered in Applicant's U.S. Pat. No. 8,671,696 and in Applicant's U.S. Pat. No. 9,376,933, each of which is hereby incorporated by reference in its entirety. The water swirled in gas turbine technology has been spoken of as improving thrust in aircraft propulsion and useful work output in form of more electricity out per unit of fuel.

In electrical generation, there is a chamber that has steam formed with one end of the gas turbine engine and at the other end, there is an extractive turbine connected to an electrical generator. The back pressure as a result of the reaction of water droplets to steam thrust impacts the turbine connected to the gas turbine's combustion section.

FIG. 3 generally illustrates the use of a combustion (gas) turbine that is installed in an environment in which electricity is generated, such as a natural-gas-fueled power plant. While this arrangement can be fairly complex, the arrangement basically involves three main sections:
The compressor, which draws air into the engine, pressurizes it, and feeds it to the combustion chamber at speeds of hundreds of miles per hour.
The combustion system, typically made up of a ring of fuel injectors that inject a steady stream of fuel into combustion chambers where it mixes with the air. The mixture is burned at temperatures of more than 2000 degrees F. The combustion produces a high temperature, high pressure gas stream that enters and expands through the turbine section.
The turbine is an intricate array of alternate stationary and rotating aerofoil-section blades. As hot combustion gas expands through the turbine, it spins the rotating blades. The rotating blades perform a dual function: they drive the compressor to draw more pressurized air into the combustion section, and they spin a generator to produce electricity.

These three primary sections are mounted on the same shaft. The rotation of the shaft drives the compressor to draw in and compress more air to sustain continuous combustion. The turbine shaft work is also used to drive other devices, such as one or more electric generators that may be coupled to the shaft. The energy that is not used for shaft work comes out in the exhaust gases, so these have either a high temperature or a high velocity. The purpose of the gas turbine determines the design so that the most desirable energy form is maximized. To optimize the transfer of kinetic energy from the combustion gases to shaft rotation, gas turbines can have multiple compressor and turbine stages.

In electricity generation, a generator is a device that converts mechanical energy to electrical energy for use in an external circuit.

In FIG. 3, a first generator 90 can be coupled to a gas turbine unit 91 at one end of a shaft that is associated with the gas turbine unit 91 and a second generator 93 can be coupled, by hot thrust gas acting on an extractive turbine 92, to the gas turbine unit 91 at the other end of the shaft. The gas turbine unit 91 can have the same or similar construction as turbine 20 of FIGS. 1 and 2. It will also be understood, as described herein, that one or more extraction turbines can be incorporated into the design. As described herein, the present invention is designed to increase the efficiency and work output of one or more electric generators 90, 93 coupled thereto. As shown, the extractive turbine 92 can be operatively connected to the gas turbine unit 91 and the second generator 93 as described herein. As discussed herein, operation (rotation) of the extractive turbine 92 can drive the second generator 93 for production of electricity.

### BRIEF DESCRIPTION OF THE DRAWING FIGURES

The invention is illustrated in the figures of the accompanying drawings which are meant to be exemplary and not limiting, in which like references are intended to refer to like or corresponding parts, and in which:

FIG. 1 is a schematic view of a conventional aircraft;

FIG. 2 illustrates various components of the conventional turbine engine;

FIG. 3 is a schematic of an electricity generating arrangement based on gas turbine technology;

FIG. 4 is a mixing unit steam chamber that can be part of a combined cycle electrical generation unit;

FIG. 4A is a front elevation view of an exemplary fluid moving device (agitator unit) that comprises a plurality of rotating blades;

FIG. 4B is a cross-sectional view showing the annular shape area (volume/concentrated area) of rapid water droplet to steam phenomena and is a region of high pressure;

FIG. 5 is a schematic showing an area of hot thrust gas and water droplets being acted on so as to be moved in a radial outward manner to form a shaped water vapor region;

FIG. 6 is a schematic view of a sealed chamber as part of a spray nozzle having an opening to disperse liquid; and

FIG. 7 is a close-up of one blade of the fluid moving device (agitator/mixer) of the present invention.

### DETAILED DESCRIPTION OF CERTAIN EMBODIMENTS

The present invention is directed to the use of a rotating agitator/mixer (fluid moving device or fluid directing member or element) to move the hot combustion gas (e.g., a thrust gas water droplet mixture) to increase thrust useful work output. As described herein, the rotating fluid moving device (agitator) can thus be understood as being a fluid mover of an agitator nature in that the rotating agitator is configured to act on fluid of a first nature so as to change a characteristic(s) thereof. For example, the rotating agitator can be configured to move the fluid in a certain manner such that the fluid assumes a concentrated area of a prescribed shape.

The water droplet to steam thrust augmentation is disclosed by the Applicant in the above mentioned patents which are incorporated herein and is a phenomena noted with a gas turbine device that operates with precipitation, etc.

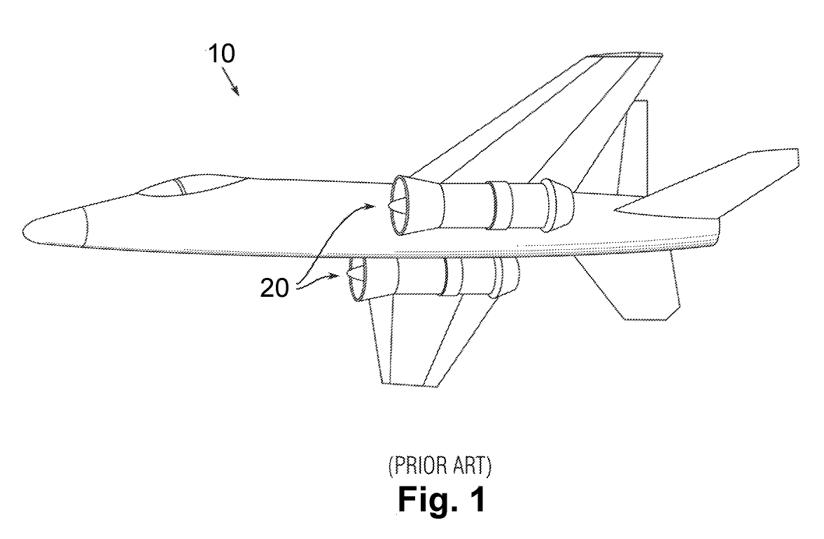

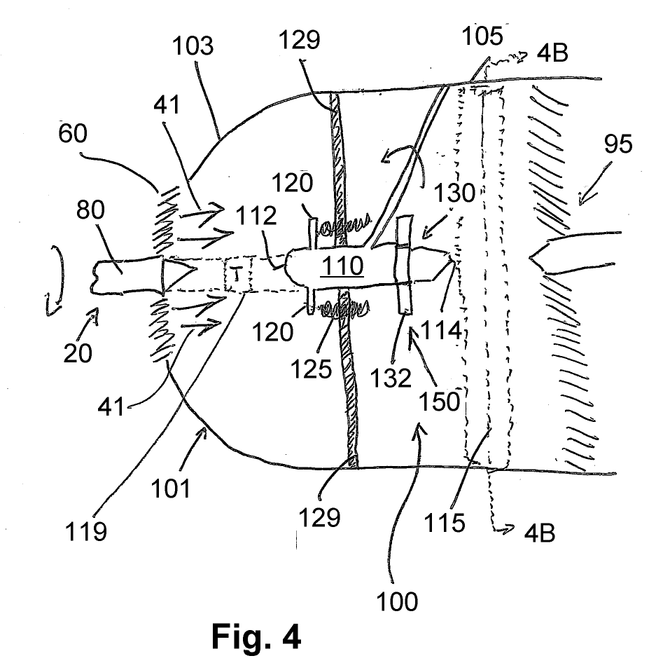

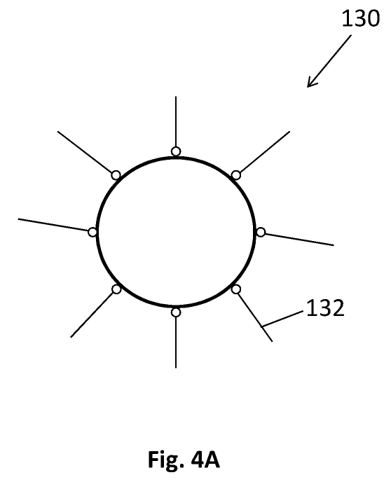

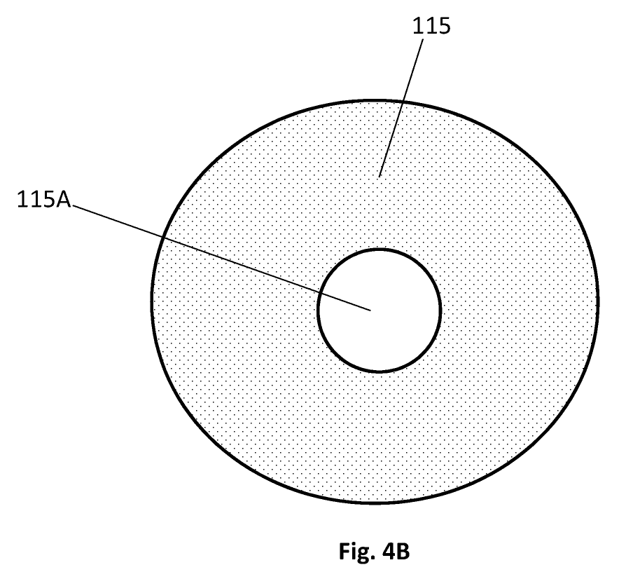

FIG. 4 illustrates a mixing unit steam (steaming) chamber 100 that can be part of a combined cycle electrical generation unit (the units can be of a 1 MW to 400 MW size according to one embodiment) or can be used in combination with other electrical generating devices, such as electrical generators 90, 93 combined with the extractive turbine 92. Chamber 100 is located downstream of a gas turbine engine, such as the engine 20 of FIG. 1, which includes a rotating shaft 80 which is partially shown. The illustrated portion of the gas turbine engine 20 is the hot end of the gas turbine engine 20 and the rotating turbine 60 is generally shown (it will be appreciated that it traditional turbine design, rotating turbines cause gas rotation, while stators are used to straighten the gas flow so that the hot thrust gas generally exits in a linear manner). Operation of the gas turbine engine 20 produces hot thrust gas which is generally indicated at 41 and flows downstream from the rotating turbine 60. The hot thrust gas 41 is at high temperature, such as 1200° F., and moves at high speed in a direction toward the mixing chamber 100 (i.e., a downstream direction).

Mixing chamber 100, that is downstream of the gas turbine engine 20, has a non-conical shape. As shown, the mixing chamber 100 can have a hemispherical (semispherical) shape or other shape that is defined by a perpendicular plane relative to a center line of the gas turbine engine or a structure that is a combination of the gas turbine engine with another unit. As shown, the mixing chamber 100 is surrounded by a housing 101 that is defined by a curved end wall 103 that is adjacent (proximate) the gas turbine engine 20 and leads to a side wall 105. The mixing chamber 100 is positioned so that the hot combustion gas (hot thrust gas) is directed into the interior of the mixing chamber 100. Unlike in conical shaped housings, the end wall 103 is not defined by tapered surfaces but instead is a curved (concave) wall. Applicant has discovered that a non-conical shape for chamber 100 optimizes fuel to energy output relative to a conically shaped chamber 100.

As described herein, the housing that contains the upstream turbine of the GTE can be thought of as being a first housing section and the mixing chamber 100 can be thought of as being a second housing section that fluidly communicates with the first housing section. The first and second housing sections can be a single integral structure.

Within the chamber 100, a rotating agitator/mixer (fluid moving element) 150 is provided downstream of the turbine engine 20. The unit 150 has a rotating shaft 110. The illustrated shaft 110 has a first end 112 and an opposing second end 114 and can take the form of an assembly that is disclosed in either of Applicant's '696 patent or '933 patent. The first end 112 is defined by a rotating spray nozzle 120 which, in this case, is powered (rotated) by rotation of the shaft 110. The second end 114 of the shaft 110, according to one embodiment of the present invention, is used to rotate blades 132 that are characterized as turbine agitation components (turbine unit 130). Supports 129 can be used to suspend the agitator/mixer 150 within the chamber 100 and can be in the form of a support member, such as a bracket, etc. that attaches to the housing 101. In other words, the unit 150 in the illustrated embodiment features two main components, namely, a component or section that sprays liquid and the downstream fluid moving device (turbine agitator component). As described herein, these components can be separated from one another.

The rotating spray nozzle 120 is thus configured to receive and discharge liquid, which is preferably water. Reference legend 125 indicates a spray/mist form of water that travels in a swirling pattern in a direction toward the turbine agitation unit 130. As discussed herein, the turbine agitation unit 130 is configured to act upon this swirling spray/mist so as to increase the useful energy output thereof.

As an alternative to driving a device (i.e., the unit 150) that is located beyond the end of the gas turbine engine shaft 80 as disclosed in Applicant's '696 patent (to impart water to hot thrust gas or as in the present invention to achieve optimal to steam and useful energy output), a shaft of unit 150 can be connected to the end of the shaft 80 and can be attached optionally to a transmission or gear box that changes the rotational speed of a second shaft on a continuation of the centerline of the gas turbine engine 20 and is connected to the device that imparts water to hot thrust gas and/or to a device (e.g., unit 150) that enhances steaming and optimizes useful energy production. Alternatively, no transmission or gear box can be present between the two shafts 80, 110.

In FIG. 4, the dashed lines between shafts 80 and 110 show such an optional coupling therebetween, with the optional transmission being shown at 119.

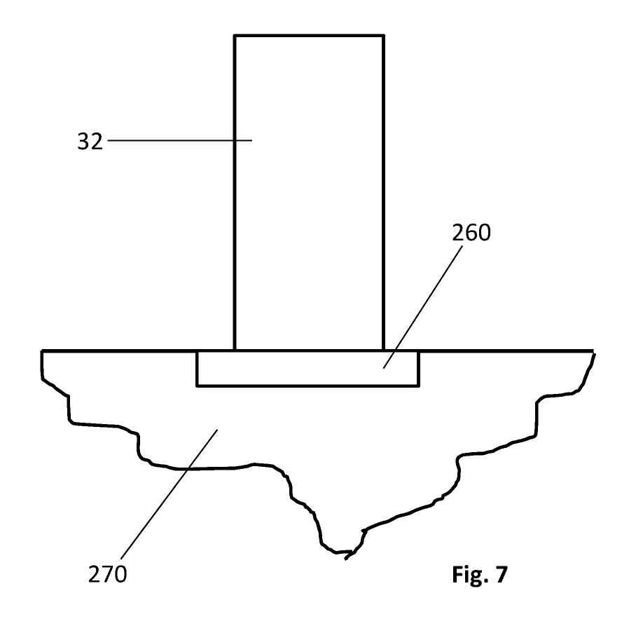

FIG. 4A is a detailed view of the blades 132 that are part of the fluid moving device (agitation unit) 130 that is disposed at the second end 114. As can be seen, the blades 132 are spaced and extend circumferentially about a common hub. Since blades 132 are coupled to the shaft 110, rotation of the shaft 110 is translated into rotation of the blades 132. It will also be appreciated that the pitch of the blades 132 can be changed with a unit operating by a centrifugal force change mechanism or other means (See, FIG. 7). The blades 132 can thus be coupled to a hub or the shaft in such a way that angle between the blade 132 and the hub or shaft can be adjusted as by using a hydraulic mechanism or the like. The blades 132 can be pivotally attached to the hub or shaft and connected to a mechanical linkage that can be controlled so as to alter the angle of the blade 132.

It will be understood that while the illustrated embodiment is one in which the spray nozzle 120 and agitation unit 130 are part of shaft 110, the agitation unit 130 can be a completely separate unit within the chamber 100. Thus, the spray nozzle 120 and the agitation unit 130 can be separated from one another and not directly coupled to one another by a common element, such as shaft 110.

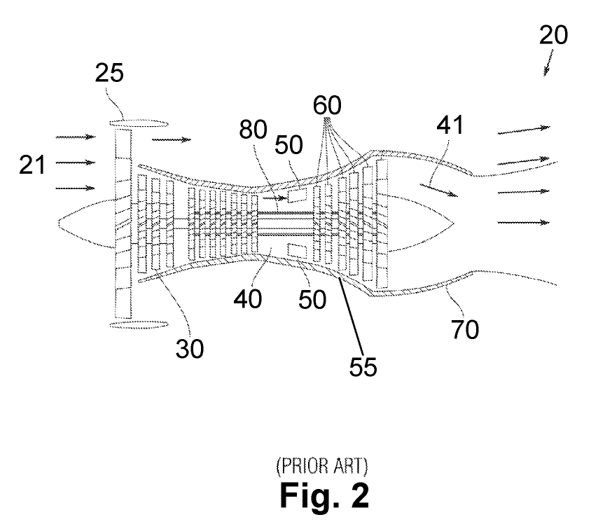

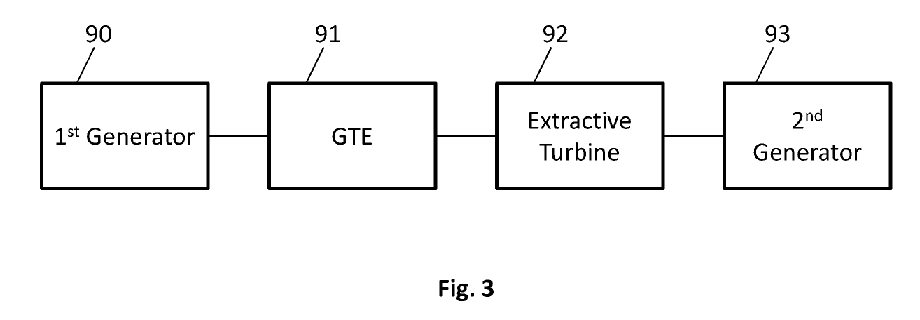

Within chamber 100 is a region 115 that is immediately downstream of the turbine agitation unit 130 and represents a region or space of intense water droplet to steam occurrence by virtue of agitation of the water droplets (i.e., moving of heated water droplets to cause a change in the water droplet quantity and/or size to optimize electricity/thrust energy output). This region 115 thus represents a concentrated area of steam. This region 115 is thus the region at which the swirling water droplets from the rotating spray nozzle 120 is further acted upon by the agitation unit 130 which agitates the swirling water droplets 125 and causes transformation into steam in the region 115. This steam in the region 115 is then used to optimize electricity/thrust energy output in the intended application which can be in the form of the electrical power generation plant (system) shown in FIG. 3 or the aircraft 10 of FIG. 1 or any other suitable application in which a gas turbine engine is employed. FIG. 4B shows the annular shape of this region 115. Generation of steam in region 115 is thus used to optimize electricity/thrust energy output of the targeted system that the present invention is incorporated (as shown in FIGS. 1-3). Area 115A represents a center of the annular region 115 and therefore, this area 115A is at least substantially aligned with the rear of the GTE unit. Area 115A is at least substantially devoid of steaming occurrence since this would lessen fuel efficiency. In other words, the area 115A is not part of the concentrated annular shaped region 115 in which water vapor (steam) is located.

Thus, in accordance with the present invention, the fluid moving device (which is a turbine in nature and defined by blades 132 that can be part of a paddle propeller or other device) acts on the combined hot thrust gas and water droplets (located immediately downstream of the sprayer) to cause the combined hot thrust gas and water droplets to move in a curved swirled motion while also being moved in a radially outward direction in the non-conical shaped housing and the action of the rotating blades (so as to form the concentrated area of steam).

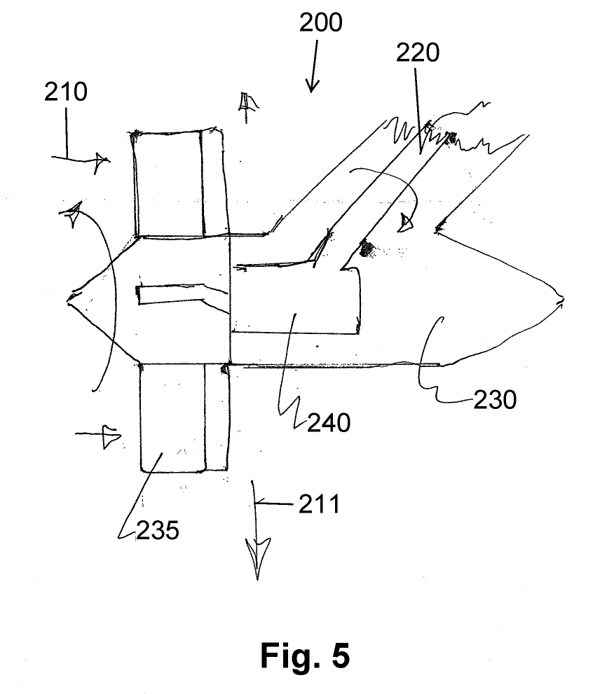

FIG. 5 illustrates a mixing unit that has a power shaft with a mixer/agitator at one end of the power shaft and a bearing at the other end. More particularly, FIG. 5 depicts a fluid moving device (mixing/agitator unit) 200 that is downstream from a compressor/turbine part of a gas turbine engine. Reference legend 210 represents thrust gas moving away from the compressor/turbine part. The thrust gas is moving at high speed and is hot and preferably includes water droplets. The thrust gas 210 as it immediately exits the turbine is at a greater temperature and as the thrust gas 210 moves downstream, heat continues to dissipate and the temperature of the thrust gas 210 is reduced. Reference legend 211 depicts radial outward movement of the thrust gas 210 and water droplets and can be thought of as a mass movement of the thrust gas 210 mixture with water droplets within the housing.

The unit 200 includes a rotating shaft drive 220 that can be associated with an electric motor/hydraulic/pin wheeling from the steaming chamber 100 or from the end of the gas turbine engine centerlined shaft 80 with or without a transmission. A bracket 230 or the like is provided and is stationary relative to the housing (casing) of the gas turbine engine 20. The bracket 230 has a rotating part 235 which moves the thrust gas and water droplets with a shaft that is approximately aligned with the centerline of the main shaft 80 of the gas turbine engine 20. A gear box or transmission 240 is provided and is configured to change direction of rotation and/or speed of rotation of an agitation/mass mover mixer assembly 250 which is configured to act upon the thrust gas/water droplet mixture in the manner described hereinbefore in that it causes a transformation to steam. In terms of applications of the present invention, it is envisioned that is can be incorporated into gas turbine engine applications which go from about 100 KW aircraft propulsion to 500 MW combined cycle electrical generation and include the electricity generation system generally shown in FIG. 3. The unit 200 thus can be configured to form an annular shaped formation of steam.

As described herein and according to one embodiment, the unit 200 can be directly connected to the main shaft of the GTE and thus, a common shaft drives both the turbine 55 of the GTE and the unit 200. It will be understood that the main shaft of the GTE can be formed of a plurality of shaft segments that are coupled to one another.

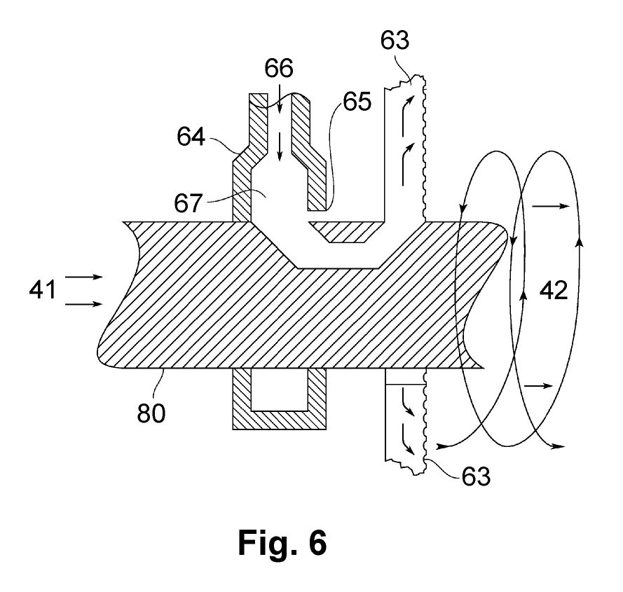

In one embodiment of the present invention, as illustrated in FIG. 6, liquid 66 flows from a liquid inlet towards rotating shaft 80 and then through a spray nozzle 63. The liquid 66 is delivered into a sealed chamber 64 having a seal opening 65 and hollow interior 67. The inlet is thus sealingly coupled to the shaft 80. The sealed chamber 64 facilitates liquid flow and surrounds the rotating shaft 80 to provide maximum cooling effect to the rotating shaft 80 and the atmosphere in the chamber 100. As the liquid 66 flows out from the open section of the seal opening 65 towards the blades 62, the liquid turns into liquid droplets 42. This transformation from liquid 66 to liquid droplets 42 is due to temperature and pressure variation. The sealed chamber 64 can be a mechanically attached washer shaped piece that allows liquid (water) to flow through and rotates at the same speed as the rotating shaft 80. In other words, a circumferential opening (e.g., 360 degree opening) is provided to allow flow of water in a 360 degree manner. Alternatively, the shaft 80 can include a flow channel that is in fluid communication with the hollow interior of the sealed chamber 64 to route the liquid through the chamber 64 into the hollow interior of the blade 63 and then to the holes formed therein for creation of the liquids droplets as described herein. The device of FIG. 6 is upstream of the rotatable agitator that acts on the swirling water droplets to form a shaped mass (concentrated area) of steam.

FIG. 7 depicts a blade or the like, such as blade 32, that is in contact with a fluid mixture composed of gas turbine engine thrust gas and water droplets. Mechanism 260 is configured to rotate and/or move the blade 32 in any direction. Hub 270 is a rotatable structure that is driven as by a drive shaft and is the member to which the blade 32 and mechanism 260 are attached.

It will be appreciated that the fluid moving device (unit 200) of the present invention is designed to act on the mixture of hot thrust gas and water droplets such that the percentage of water vapor (steam) progressively increases in a downstream direction from the spray nozzle toward the fluid moving device and the action of the fluid moving device itself causes the mixture of hot thrust gas and water droplets to be at least substantially converted into all water vapor (steam). In other words, when the water droplets are discharged into the hot thrust gas by the spray nozzle or the like, a small percentage of the water droplets is converted immediately into steam but of the water mass remains in water droplet form until the water droplet are acted upon by the fluid moving device which converts most if not all of the water droplets into water vapor (steam) which is then used downstream as part of the present invention (such that back pressure is eliminated and optimized electricity generation results).

In one embodiment, there is a relationship between the dimensions of the fluid moving device and the downstream extractive turbine in that the fluid moving device has a size such that it forms the annular shaped region of water vapor that flows at high speeds immediately into the turbine blades of the extractive turbine. In other words, the fluid moving device and the extractive turbine are axially aligned and sized so that the formed region of water vapor is positioned so as to make direct contact with the turbine blades of the downstream extractive turbine.

In addition, the size and non-conical shape of the housing is purposely defined such that the volume of the thrust gas leaving the GTE is increased due to the housing containing the fluid moving device having a greater width and initially the hot thrust gas has no added water volume prior to encountering the spray device. Applicant's own patents mentioned above describe disposing water into and through the end of the main shaft and the turbine blades themselves such that the water is sprayed from the turbine blades and in some cases, the sprayed water droplets strike one or more impinging members to create fine droplets. Whereupon discharge of the water droplets into the hot thrust gas results in some cooling of the thrust gas; however, the conversion of the water droplet to vapor (steam) results in a volume increase. That is why the housing that contains the fluid moving device can be referred to as a steaming chamber in which the mixture of hot thrust gas and water droplets are converted into water vapor (steam).

It will be appreciated that the fluid moving device (mixer/agitator) of the present invention is configured such that the fluid mixture is composed of gas turbine engine thrust gas and water droplets, generated upstream thereof, encounters and is acted upon by the fluid moving device (mixer/agitator) such that an annular shaped steam product is generated around the fluid moving device (mixer agitator). This annular shaped steam product (concentrated area of steam) continues to flow downstream, whereby useful energy output is increased. For example, downstream of the fluid moving device (mixer/agitator) can be an extractive turbine from which electrical generation occurs and yields a combined cycle benefit (See, FIG. 4 which shows an optional extractive turbine at 95 which is downstream, of region 115 in which an annular shaped steam mass is formed). It will also be appreciated that the fluid moving device (mixer/agitator arrangement) disclosed herein can be used for aircraft propulsion. In addition, other points of the present invention are as follows: (1) the rotatable fluid moving device (agitator) can be powered by a rotation shaft or electric motor or pin wheel or other means; (2) the resulting annular shaped steam (as a result of the water droplets being converted to steam (gas) does not diminish the useful output by acting on the gas turbine engine section, i.e., generating undesired back pressure; (3) the blades of the agitator can be of a non-symmetrical shape to achieve radial movement of the mixture of hot trust gas and liquid (e.g., water) droplets from a centerline of the main shaft; (4) the apparatus yields useful energy output increase with droplets of other volatile liquids, such as alcohol; (5) the agitator unit can be coupled to any source of combustion gas, such as an internal combustion engine or a fired boiler, or other apparatus that burns a fuel source and generates hot gas; (6) the agitator can be coupled to a turbo charged compression ignition engine and there is an extractive turbine and/or centrifugal rotor acting on increasing energy output; (7) the agitator can be attached to a fired boiler flue gas outlet and there is an extractive turbine acting on increasing energy output; (8) the agitator can be coupled to an internal combustion engine reciprocating on an aircraft or other applications and there is a conversion of currently wasted thermal energy into thrust energy; and (9) the apparatus can include more than one extractive turbine that recovers energy which can then be used to drive another device, such as an electric generator.

As is known, an extraction turbine is a steam turbine that is provided with taps through which steam may be drawn off at various stages for purposes (such as heating) other than driving the turbine.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A gas turbine engine that includes a compressor and a combustion chamber that generates hot thrust gas, the gas turbine engine comprising:
a first housing section;
a first rotatable shaft disposed within the first housing section;
a turbine blade assembly that is downstream of the combustion chamber and is rotatable with the first rotatable shaft within the first housing section, the turbine blade assembly including a plurality of turbine blades; and
a unit that is disposed downstream of the turbine blade assembly for increasing the thrust of the gas turbine engine, the unit including:
a second housing section that is coupled to and in fluid communication with the first housing section for receiving the hot trust gas from the turbine blade assembly;
a second rotatable shaft centrally disposed within the unit housing;
a rotatable fluid moving device that is coupled to the second rotatable shaft and configured such that the rotatable fluid moving device acts on the hot thrust gas from the turbine blade assembly and directs the hot thrust gas in a radially outward direction to cause the hot trust gas to assume a concentrated area of hot thrust gas within the second housing section such that useful energy output is increased.

2. The gas turbine engine of claim 1, wherein the rotatable fluid moving device is configured such that the hot thrust gas exit the unit with increased thrust.

3. The gas turbine engine of claim 1, wherein the second housing section has a non-conical shape.

4. The gas turbine engine of claim 3, wherein an interface between the first housing section and the second housing section is defined by a curved wall.

5. The gas turbine engine of claim 3, wherein the second housing section has a greater area than the first housing section.

6. The gas turbine engine of claim 1, wherein the concentrated area has an annular shape defined by a plane that is perpendicular to a centerline of the first rotatable shaft.

7. The gas turbine engine of claim 1, wherein the fluid moving device comprises a second turbine assembly defined by a plurality of turbine blades that rotate.

8. The gas turbine engine of claim 7, wherein a pitch of each turbine blade can be adjusted.

9. The gas turbine engine of claim 1, wherein the unit includes a source of liquid and a spray nozzle device that rotates with the second rotatable shaft, the spray nozzle device being configured to produce liquid droplets as a result of the liquid being forced through nozzles of the spray nozzle device under pressure to create the liquid droplets for discharge downstream of the spray nozzle device but upstream of the rotatable fluid moving device, wherein rotation of the rotatable fluid moving device and discharge of the liquid in droplet form in the hot thrust gas causes the liquid droplets to be converted into a mass of steam that assumes the concentrated area about and immediately downstream of the rotatable fluid moving device due to the rotatable fluid moving device acting upon the moving mass of steam.

10. The gas turbine engine of claim 9, wherein the concentrate area has an annular shape.

11. The gas turbine engine of claim 1, further including an extraction turbine that is downstream of the unit and configured to generate electricity.

12. The gas turbine of claim 9, wherein the spray nozzle device and rotatable fluid moving device are both fixedly attached to the second rotatable shaft.

13. The gas turbine engine of claim 1, wherein the second housing section has a hemispherical shaped inlet portion and the first housing section has cylindrical shape.

14. The gas turbine engine of claim 1, wherein the first and second rotatable shafts are coupled to one another.

15. The gas turbine engine of claim 14, wherein at least one of a transmission and gear box is provided between the first and second rotatable shafts for optimizing rotational speed thereof.

16. A system for increasing useful energy output comprising:
a source of hot combustion gas; and
an apparatus that is disposed downstream of and received the hot combustion gas, the apparatus including:
a housing that is coupled to the source and receives the hot combustion gas;
a rotatable shaft centrally disposed within the housing;
a rotatable fluid moving device coupled to the second rotatable shaft and configured such that the rotatable fluid moving device directs the hot combustion gas in a radially outward manner so as to form a concentrated area within the housing such that useful energy output is increased.

17. The system of claim 16, wherein the source of hot combustion gas is selected from the group consisting of: an internal combustion engine and a fired boiler that generates flue gas.

18. The system of claim 16, wherein the apparatus is coupled to an internal combustion engine reciprocating on an aircraft and the apparatus converts currently wasted thermal energy into thrust energy.

19. The system of claim 16, wherein the apparatus includes a source of liquid and a spray nozzle device that rotates with the rotatable shaft, the spray nozzle device being configured to produce liquid droplets as a result of the liquid being forced through the spray nozzle device under pressure to the create the liquid droplets for discharge downstream of the spray nozzle device but upstream of the rotatable fluid moving device, wherein rotation of the rotatable fluid moving device and discharge of the liquid in droplet form in the hot combustion gas causes the liquid droplets to be converted into steam that assumes the concentrated area about the rotatable fluid moving device.

20. The system of claim 16, wherein the concentrated area has an annular shape.
